(19) United States
(12) Patent Application Publication
(10) Pub. No.: US 2015/0047942 A1
(43) Pub. Date: Feb. 19, 2015

(54) HIGH-SPEED COUPLING SUBASSEMBLY AND HIGH-SPEED OVERRUNNING CLUTCH ASSEMBLY INCLUDING THE SUBASSEMBLY

(71) Applicants: Paul H. Cook, Borden, IN (US); Means Industries, Inc., Saginaw, MI (US)

(72) Inventors: John W. Kimes, Wayne, MI (US); Paul H. Cook, Borden, IN (US)

(21) Appl. No.: 14/457,245

(22) Filed: Aug. 12, 2014

Related U.S. Application Data
(63) Continuation-in-part of application No. 14/449,312, filed on Aug. 1, 2014.
(60) Provisional application No. 61/866,121, filed on Aug. 15, 2013.
(60) Provisional application No. 61/925,872, filed on Jan. 10, 2014.

(51) Int. Cl. F16D 7/04

(52) U.S. Cl. CPC F16D 7/04
USPC 192/56.1

(57) ABSTRACT

A high-speed coupling subassembly and a high-speed overrunning clutch assembly including the subassembly are provided. The subassembly includes a powdered metal member. The member includes an axially extending coupling portion and a recess portion. The recess portion has a coupling face and a joining face spaced apart from the coupling face and being formed with a first pilot. The coupling face has at least one recess. Each of the recesses defines a load-bearing shoulder. A powdered metal hub includes an axially extending connecting portion and a mounting portion being formed with a second pilot. The mounting portion of the hub is joined to the recess portion of the member at a joint at the joining face. The first and second pilots are in contact at a pilot diameter to concentrically align the hub and the member during joining to improve performance of the assembly during a high-speed overrun condition.

### CROSS-REFERENCE TO RELATED APPLICATION

This application claims the benefit of U.S. provisional applications Ser. No. 61/866,121 filed Aug. 15, 2013 and Ser. No. 61/925,872, filed Jan. 10, 2014 and is a continuation-in-part of U.S. patent application entitled “Coupling Assembly Having Reduced Undesirable Noise And Contact Stress Caused By A Transition Between Operating Modes Of The Assembly” filed on Aug. 1, 2014 and having U.S. Ser. No. 14/449,312 (attorney docket no. MEII 0325 PUSP).

### TECHNICAL FIELD

### Overview

(1) Field of the Invention

This invention relates to powdered metal coupling member such as pocket plates and clutch assemblies including such coupling members.

(2) Background Art

Coupling assemblies such as clutches are used in a wide variety of applications to selectively couple power from a first rotatable driving member, such as a driving disk or plate, to a second, independently rotatable driven member, such as a driven disk or plate. In one known variety of clutches, commonly referred to as “one-way” or “overrunning” clutches, the clutch engages to mechanically couple the driving member to the driven member only when the driving member rotates in a first direction relative to the driven member. Once so engaged, the clutch will release or decouple the driven member from the driving member only when the driving member rotates in a second, opposite direction relative to the driven member. Further, the clutch otherwise permits the driving member to freely rotate in the second direction relative to the driven member. Such “freewheeling” of the driving member in the second direction relative to the driven member is also known as the “overrunning” condition.

One type of one-way clutch includes coaxial driving and driven plates having generally planar clutch faces in closely spaced, juxtaposed relationship. A plurality of recesses or pockets is formed in the face of the driving plate at angularly spaced locations about the axis, and a strut or pawl is disposed in each of the pockets. Multiple recesses or notches are formed in the face of the driven plate and are engageable with one or more of the struts when the driving plate is rotating in a first direction. When the driving plate rotates in a second direction opposite the first direction, the struts disengage the notches, thereby allowing freewheeling motion of the driving plate with respect to the driven plate.

For purposes of this disclosure, the term “coupling” should be interpreted to include clutches or brakes wherein one of the plates is drivably connected to a torque delivery element of a transmission and the other plate is drivably connected to another torque delivery element or is anchored and held stationary with respect to a transmission housing. The terms “coupling”, “clutch” and “brake” may be used interchangeably.

A pocket plate may be provided with angularly disposed recesses or pockets about the axis of the one-way clutch. The pockets are formed in the planar surface of the pocket plate. Each pocket receives a torque transmitting strut, one end of which engages an anchor point in a pocket of the pocket plate. An opposite edge of the strut, which may hereafter be referred to as an active edge, is movable from a position within the pocket to a position in which the active edge extends outwardly from the planar surface of the pocket plate. The struts may be biased away from the pocket plate by individual springs.

A notch plate may be formed with a plurality of recesses or notches located approximately on the radius of the pockets of the pocket plate. The notches are formed in the planar surface of the notch plate.

Another example of an overrunning planar clutch is disclosed in U.S. Pat. No. 5,597,057.

Some U.S. patents related to the present invention include: U.S. Pat. Nos. 5,070,978; 5,449,057; 5,806,643; 5,871,071; 5,918,715; 5,964,331; 5,927,455; 5,979,627; 6,065,576; 6,116,394; 6,125,980; 6,129,190; 6,186,299; 6,193,038; 6,244,965; 6,386,349; 6,481,551; 6,505,721; 6,571,926; 6,730,263; 6,854,577; 7,258,214; 7,320,240; 7,344,010; 7,484,605; 8,424,204; 8,500,594; and 8,602,189.

Yet still other related U.S. patents include: U.S. Pat. Nos. 4,200,002; 5,954,174; and 7,025,188.

U.S. Pat. No. 6,854,577 discloses a sound-dampened, one-way clutch including a plastic/steel pair of struts to dampen engagement clunk. The plastic strut is slightly longer than the steel strut. This pattern can be doubled to dual engaging. This approach has had some success. However, the dampening function stopped when the plastic parts became exposed to hot oil over a period of time.

Other U.S. patent documents related to at least one aspect of the present invention includes U.S. Pat. Nos. 8,491,440; 8,491,439; 8,187,141; 8,079,453; 8,007,396; 7,690,492; 7,661,518; 7,455,157; 7,455,156; 7,451,862; 7,448,481; 7,383,930, 7,100,756; and 6,290,044; and U.S. published application Nos. 2012/0152683; 2012/0149518; 2012/0145505; 2011/0297500; 2010/0105515; 2009/0233755; 2009/0098970; 2009/0062058; 2008/0188338; 2007/0084694; and 2006/0021838.

Pocket plates or members for use in one-way ratcheting type coupling or clutch assemblies are typically formed using powdered ferrous metals. In contrast to other metal-forming techniques, powdered metal (PM) parts are shaped directly from powder, whereas castings originate from molten metal.

Other methods of forming pocket plates have been tried in an attempt to reduce cost. For example, U.S. Pat. No. 6,333,112 discloses a laminated pocket plate. U.S. Patent Publication No. 2008/0135369 discloses a stamped clutch pocket plate. U.S. Pat. No. 6,125,980 discloses a pocket plate integrated within a hub such as by casting or molding to form an integral assembly. The hub comprises an aluminum alloy casting or a phenolic molding. The pocket plate itself is preferably a powdered metal part.

The most common PM process—often referred to as conventional PM processing—involves compressing metal powder in a precision tool set and then heating it to form metallurgical bonds. The resulting sintered part is very often the end product, secondary operations are not necessary, one of the main benefits of powder metallurgy.

A further significant advantage is that the PM process conserves natural resources by utilizing recycled raw materials. A low emission manufacturing process and avoiding or minimizing wasteful secondary operations, further minimize environmental impact.

The PM process uses highly consistent, engineered elemental or alloyed metal powders. The majority of products are manufactured from material compositions defined by national or international standards.

The raw material powder is subsequently processed or compacted in a closed die to form the near-net-shape (identical to or very similar to final dimensions) “green” compact.

The “green” compacts are subsequently heated in a continuous sintering furnace to an elevated temperature and in a protective atmosphere in order to form metallurgical integrity. Consistency is assured by applying precise temperature and atmospheric controls.

It may be of advantage to run the sintering process in two stages, namely in the form of what is referred to as pre-sintering, which takes place at a temperature below the temperature of the second sintering step, followed by what is referred to as high-temperature sintering. This enables higher carbon contents to be obtained without the risk of brittle cracking during the hardening reaction, thereby generally enabling greater strength to be imparted to the sintered component.

Secondary operations are selectively applied to either improve dimensional tolerance, or to achieve geometries that cannot be formed in the compaction process. Sizing is a high speed pressing operation process which improves profile tolerance. Typical machining processes such as turning, milling, drilling and threading can be applied when required. PM products can be successfully joined to other PM or non-PM products using various processes.

As the powder metal (PM) industry continues to advance the complexity of near-net shape processing, many product designs incorporate joining techniques to construct a component from several compacted pieces. This permits PM to expand its capability and compete against traditional fabrication practices in providing cost-effective complex parts for a variety of applications.

Sinter-brazing is one such joining method that serves as a suitable means to efficiently bond parts. While the brazing mechanism itself is highly complicated and perhaps not fully understood, the general practice is fairly straightforward and can alleviate additional processing steps in a manufacturing setting. It enables a feasible approach to what would otherwise be a two-step process in PM (i.e. adhesive bonding or welding after sintering) to be accomplished in one step through simultaneously sintering and bonding of green parts under a controlled atmosphere.

Economic advantages are realized in selecting PM processing in coordination with sinter-brazing, especially in comparison with costly and time-consuming machining of wrought or cast parts to achieve a similar design. Sinter-brazing has become a joining technology in the manufacture of net shape parts, as it has been successfully applied in production of transfer case planetary gear carriers and reduction hubs for the automotive industry. The metallic bond created between parent metal surfaces is generally sufficiently strong enough to withstand the requirements expected out of high performance PM components. See U.S. Pat. No. 8,500,594. Also see U.S. Pat. Nos. 8,535,605 and 7,416,621 which described tempering.

One problem associated with joining powdered metal parts to form a subassembly or assembly is that at high rotary speeds (i.e., over 6,000 RPM) the joint between the parts may fail due to vibration caused by part imbalance. Vibration may occur due to one part having an incorrect concentric alignment with the axis of rotation of the other part.

### Summary of Example Embodiments

An object of at least one embodiment of the present invention is to provide a high-speed coupling subassembly and high-speed overrunning clutch assembly including the subassembly at a relatively low cost by separately making a PM hub and a PM coupling member and then joining the parts together at a high strength joint to form a one piece part having good geometry and concentricity.

In carrying out the above object and other objects of at least one embodiment of the present invention, a high-speed coupling subassembly for an overrunning coupling assembly is provided. The subassembly includes a powdered metal member having a large number of pores. The member includes an axially extending coupling portion and a recess portion. The recess portion has a coupling face and a joining face spaced apart from the coupling face and being formed with a first pilot. The member is mounted for rotation about an axis. The coupling face has at least one recess. Each of the recesses defines a load-bearing shoulder. The subassembly also includes a powdered metal hub having a large number of pores. The hub includes an axially extending spline portion and a mounting portion being formed with a second pilot. The mounting portion of the hub is joined to the recess portion of the member at a joint at the joining face. The first and second pilots are in contact at a pilot diameter to concentrically align the hub and the member during joining to improve performance of the assembly during a high-speed overrun condition.

The joint may be a brazed joint comprising a solid metal layer to bond the member and the hub together. The brazed joint may include a brazed alloy infiltrated into the pores of the hub and the member.

Each recess may be sized and shaped to receive and retain a locking member that moves in its recess during the overrun condition of the assembly.

The first and second pilots may be curved surfaces.

The member may be a pocket plate member.

Each locking member may be either a locking strut or an impact energy storage element.

The first and second pilots may be annular surfaces.

The member may be a clutch member.

Each recess may have a “T” shape.

Each recess may have an inner recess for receiving a biasing spring.

The coupling face may be oriented to face axially along the axis.

Further in carrying out the above object and other objects of at least one embodiment of the present invention, a high-speed overrunning clutch assembly is provided. The assembly includes powdered metal first and second clutch members. Each of the members has a large number of pores and each of the members includes an axially extending coupling portion and a recess portion. Each recess portion has a coupling face. The recess portion of the first clutch member has a joining face spaced apart from its coupling face and the joining face is formed with a first pilot. The first member is mounted for rotation about an axis. The coupling face of each recess portion has at least one recess. Each of the recesses defining a load-bearing shoulder. The assembly further includes a powdered metal hub having a large number of pores. The hub includes an axially extending connecting portion and a mounting portion being formed with a second pilot. The mounting portion of the hub is joined to the recess portion of the first member at a joint at the joining face. The first and second pilots are in contact at a pilot diameter to concentrically align the hub and the first member during joining to improve performance of the assembly during a high-speed overrun condition.

The joint may be a brazed joint comprising a solid metal layer to bond the first member and the hub together. The brazed joint may include a brazed alloy infiltrated into the pores of the hub and the first member.

Each recess of the first member may be sized and shaped to receive and retain a locking member that moves in its recess during the overrun condition of the assembly.

The first and second pilots may be curved surfaces.

The first member may be a pocket plate member.

Each locking member may be either a locking strut or an impact energy storage element.

The first and second pilots may be annular surfaces.

Each recess of the first member may have a “T” shape.

Each recess of the first member may have an inner recess for receiving a biasing spring.

Each coupling face may be oriented to face axially along the axis.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### BRIEF DESCRIPTION OF THE DRAWINGS

FIG. 1 is a perspective view of a high-speed one-way clutch assembly including a hub constructed in accordance with at least one embodiment of the present invention;

FIG. 2 is another perspective view of the embodiment of FIG. 1 taken from the opposite end of the assembly;

FIG. 3 is an exploded perspective view of the assembly of FIGS. 1 and 2 and showing a subassembly constructed in accordance with at least one embodiment of the present invention;

FIG. 4 is another exploded perspective view of the assembly of FIGS. 1 and 2 taken from the opposite end of the assembly;

FIG. 5a is a sectional view of the assembly of FIGS. 1-4;

FIG. 5b is an enlarged view, partially broken away and in cross section, of a portion of the view of FIG. 5a; and

FIG. 6 is a process flow chart illustrating the various steps to manufacture the assembly of FIGS. 1-4 with the finished assembly indicated by two different perspective views at the bottom of the figure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

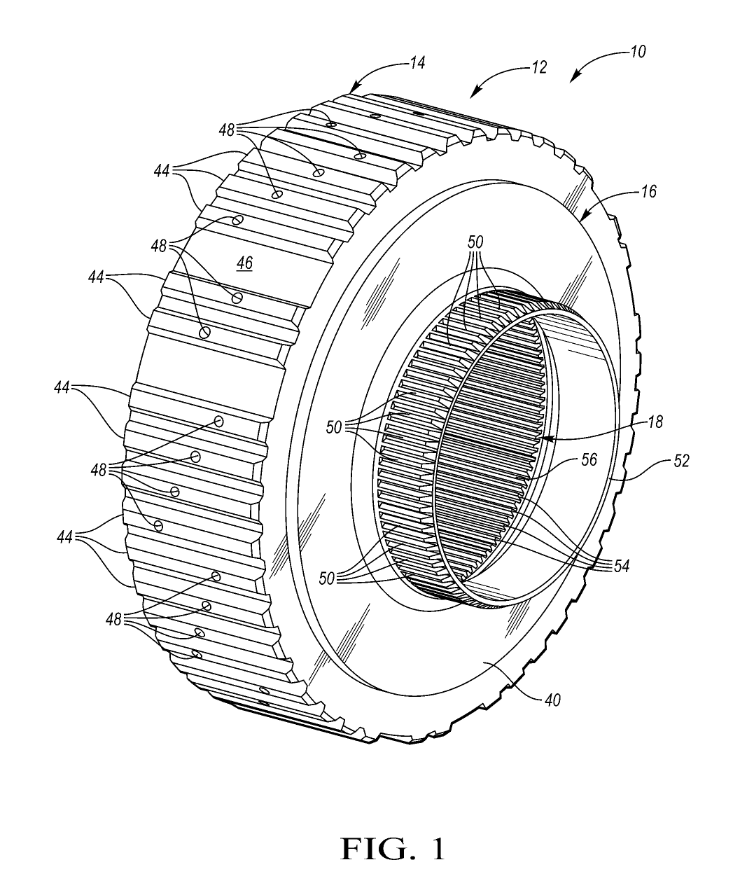

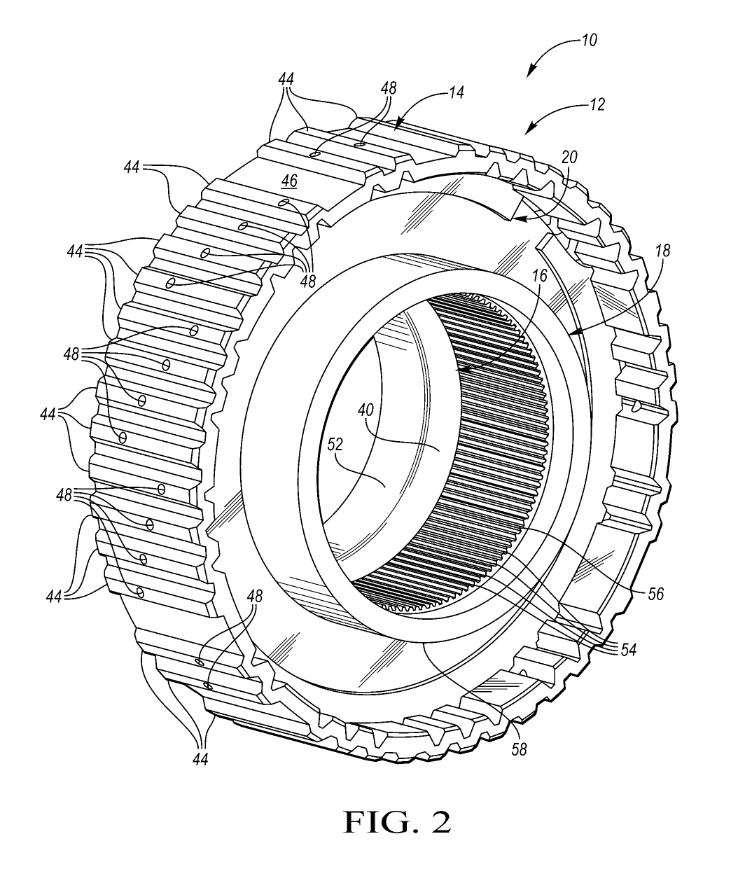

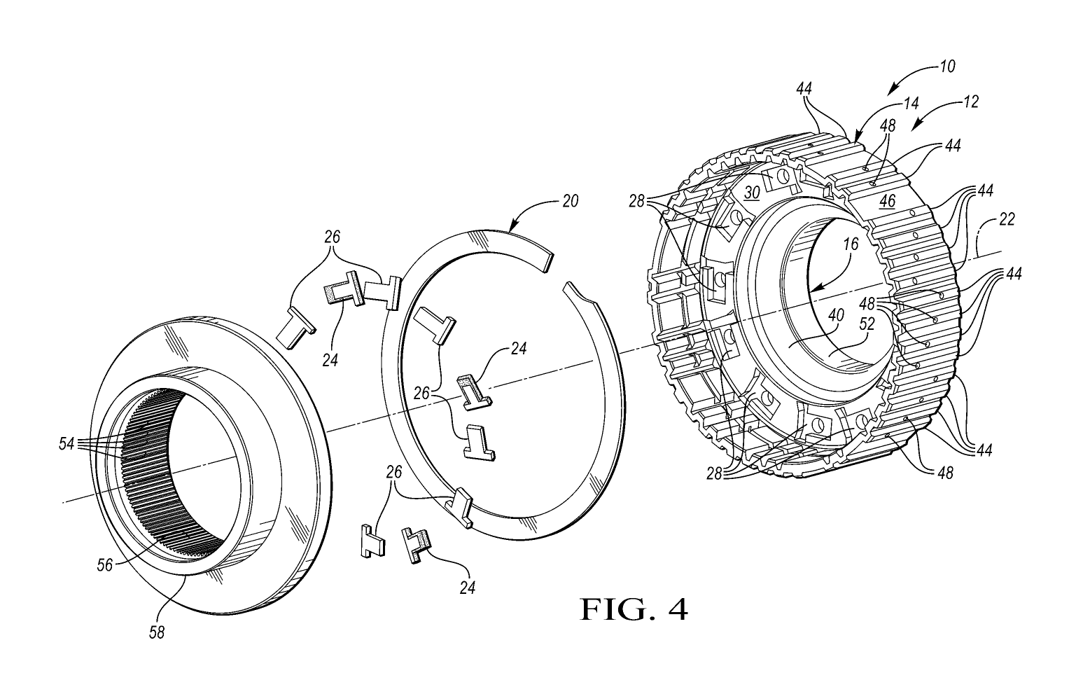

Referring now to FIGS. 1-5b there is illustrated a high-speed overrunning clutch assembly, generally indicated at 10. The assembly 10 includes a high-speed coupling subassembly, generally indicated at 12, assembled to the rest of the overrunning coupling assembly 10. The subassembly 12 includes a powdered metal first clutch member or pocket plate member, generally indicated at 14. It is to be understood that instead of a pocket plate member a rocker plate member may be used.

The pocket plate member 14 has a large number of pores, has an axially extending coupling or spline portion 46 and a recess portion 36. Splines 44 are formed on an outer circumferential surface of the spline portion 46. The recessed portion 36 includes a coupling face 30 and a joining face 38 spaced apart from the coupling face 30 and being formed with a first pilot in the form of an annular curved surface 37. The joining face 38 and the first pilot 37 are typically machined (i.e. by turning) into the recess portion 36 of the member 14 and provides or defines a precision pilot diameter to concentrically align the member 14 with a hub, generally indicated at 16, during a joining process such as a sinter-brazing process to improve performance of the assembly 10 during a high-speed overrun condition of the assembly 10. Other joining processes may be used such as using fasteners (i.e. such as rivets) or by welding (i.e. projection welding, laser welding, EB welding and friction welding).

The recess portion 36 of the member 14 also includes a recess 28 which has a “T” shape and which, in turn, has an inner recess for receiving a biasing spring (not shown). Each recess 28 is sized and shaped to receive and retain a locking member such as either a locking strut 26 or an impact energy storage element such as a storage element 24 which is described in detail in U.S. provisional patent application Ser. No. 61/866,121 filed Aug. 15, 2013 which is hereby incorporated in its entirety by reference herein. Each storage element 24 may include a rigid insert and an elastomeric outer covering layer surrounded and bonded to the insert. The elements 26 and 24 are movable between first and second positions. The first position is characterized by abutting engagement of the locking element 26 or element 24 with a respective shoulder of the member 14 and a shoulder or locking formation 32 of a notch member or plate 18. The second position is characterized by non-abutting engagement of the locking element 26 or element 24 with at least one of the members 14 and 18. It is to be understood that when a rocker plate member is used the locking members may be rockers.

The energy storage elements 24, as well as the locking elements 26, are disposed at annularly spaced positions about an axis 22 to dampen and/or lock the rotation between the members 14 and 18.

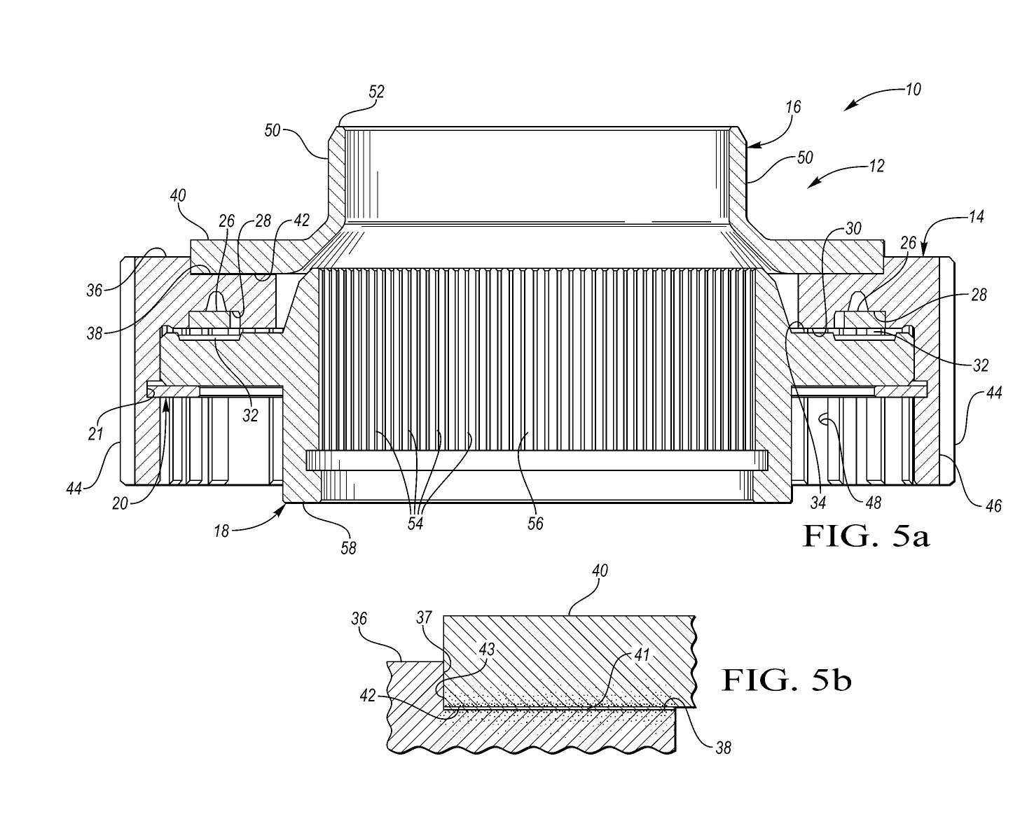

The subassembly 12 also includes the powdered metal hub 16 which also has a large number of pores. The hub 16 includes an axially extending spline or connecting portion 52 including a plurality of splines 50 circumferentially disposed thereon. The hub 16 also includes a mounting or flange portion 40 being formed with a second pilot in the form of an annular axially extending surface 43. The mounting portion 40 of the hub 16 is joined to the recess portion 36 of the member 14 at a joint as shown in FIG. 5b at the joining face 38 of the portion 36. As shown in FIGS. 5a and 5b, the first and second pilots 37 and 43, respectively, are in contact at a pilot diameter to concentrically align the hub 16 and the member 14 during joining to improve performance of the assembly 10 during a high-speed overrun condition. The joint may be a brazed joint comprising a solid metal layer 41 to bond the member 14 and the hub 16 together. The brazed joint may include a brazed alloy infiltrated in the pores of the hub 16 and the member 14 as shown in FIG. 5b.

The assembly 10 also includes a powdered metal second clutch or notch plate member, generally indicated at 18, which also has a large number of pores and an axially extending spline or coupling portion 56 having a large number of axially extending splines 54. The clutch or notch plate member 18 further includes the large number of locking formations 32 which are separated by a large number of recessed portions on an annular surface or face 34 of the clutch member 18. The surface 34 forms a coupling face of the clutch member 18.

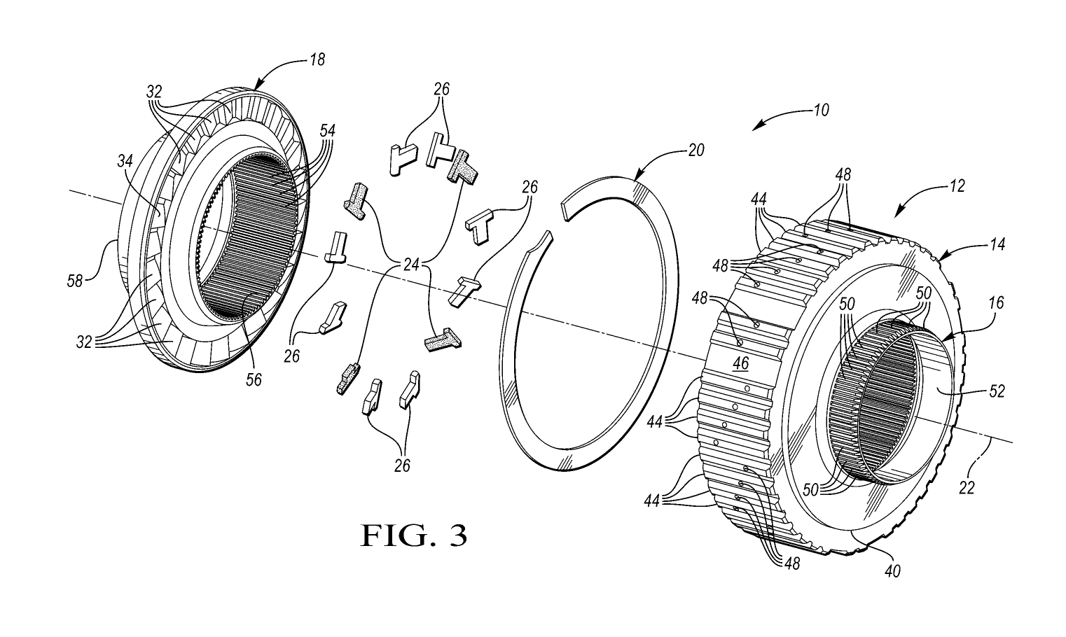

As shown in FIGS. 3-5a, the assembly 10 also preferably includes a locking ring, generally indicated at 20, which is disposed within a locking groove 21 in the axially extending coupling portion 46 of the member 14 to hold the members 14 and 16 together.

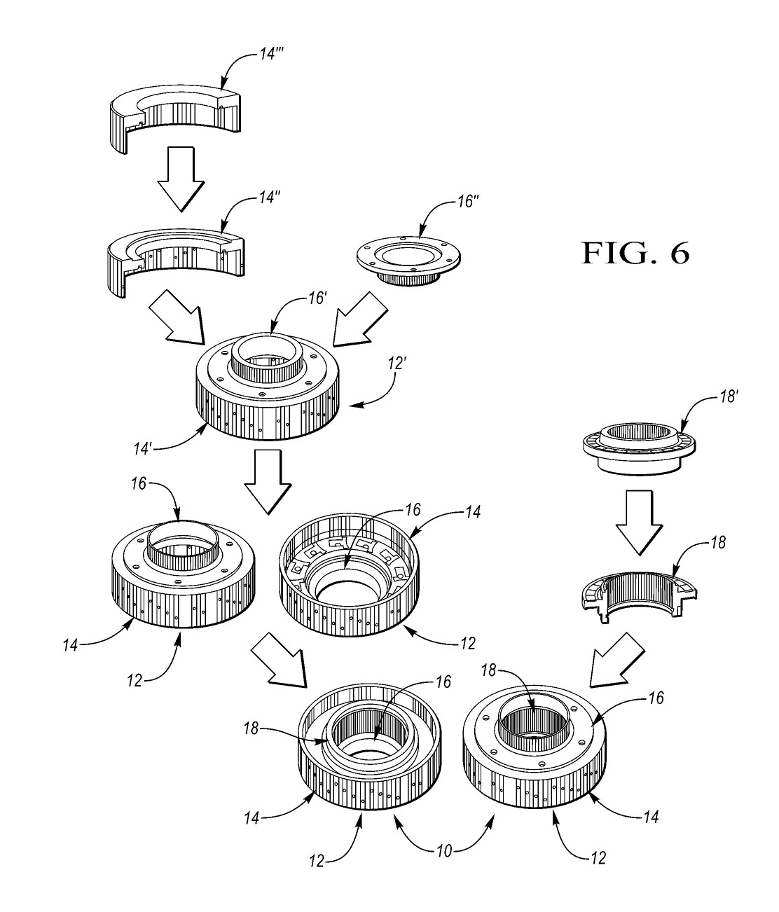

Referring now to FIG. 6, there is illustrated a process map or flow for manufacturing the components or members 14, 16 and 18 which are assembled to form the assembly 10. Initially, powdered metal is compacted and pre-sintered to form a pocket plate body, generally indicated at 14′″ as shown in the upper left hand corner of the drawing figure. Then the pocket plate body 14′″ is machined by turning to form the joining face and the first pilot in the recess portion of a member 14″. Also lube holes 48 may be drilled in the coupling portion. As generally indicated at 16″, a pocket plate hub is compacted from powdered metal and pre-sintered and sized to form a hub 16′. The hub 16′ and the pre-sintered pocket plate body 14″ are then assembled together to form the subassembly 12′. Prior to assembling the hub 16′ with the member 14′, a slug of brazing alloy is positioned between the mounting flange of the hub 16′ and the recess portion of the member 14′. Then the entire subassembly 12′ is sintered at a high temperature and tempered. The resulting subassembly 12 is shown in two perspective views wherein the inner circumferential surface of the axially extending spline portion of the member 14 is turned and balanced to form the finished machined pocket plate subassembly 12.

As shown on the right hand side of FIG. 6, a notch plate 18′ is formed by compacting powdered metal and is sinter hardened and tempered to form the notch plate 18′. Then the notch plate 18′ is turned to form a finished machined notch plate 18. Then the subassembly 12 and the notch plate 18 are assembled together to form the resulting assembly 10 which is shown in two different perspective views at the bottom of FIG. 6.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A high-speed coupling subassembly for an overrunning coupling assembly, the subassembly comprising:
a powdered metal member having a large number of pores, the member including an axially extending coupling portion and a recess portion, the recess portion having a coupling face and a joining face spaced apart from the coupling face and being formed with a first pilot, wherein the member is mounted for rotation about an axis, the coupling face having at least one recess, each of the recesses defining a load-bearing shoulder; and
a powdered metal hub having a large number of pores, the hub including an axially extending spline portion and a mounting portion being formed with a second pilot wherein the mounting portion of the hub is joined to the recess portion of the member at a joint at the joining face and wherein the first and second pilots are in contact at a pilot diameter to concentrically align the hub and the member during joining to improve performance of the assembly during a high-speed overrun condition.

2. The subassembly as claimed in claim 1, wherein the joint is a brazed joint comprising a solid metal layer to bond the member and the hub together.

3. The subassembly as claimed in claim 2, wherein the brazed joint includes a brazed alloy infiltrated into the pores of the hub and the member.

4. The subassembly as claimed in claim 1, wherein each recess is sized and shaped to receive and retain a locking member that moves in its recess during the overrun condition of the assembly.

5. The subassembly as claimed in claim 1, wherein the first and second pilots are curved surfaces.

6. The subassembly as claimed in claim 1, wherein the member is a pocket plate member.

7. The subassembly as claimed in claim 4, wherein each locking member is either a locking strut or an impact energy storage element.

8. The subassembly as claimed in claim 1, wherein the first and second pilots are annular surfaces.

9. The subassembly as claimed in claim 1, wherein the member is a clutch member.

10. The subassembly as claimed in claim 1, wherein each recess has a “T” shape.

11. The subassembly as claimed in claim 1, wherein each recess has an inner recess for receiving a biasing spring.

12. The subassembly as claimed in claim 11, wherein the coupling face is oriented to face axially along the axis.

13. A high-speed overrunning clutch assembly comprising:
powdered metal first and second clutch members, each of the members having a large number of pores and each of the members including an axially extending coupling portion and a recess portion, each recess portion having a coupling face, the recess portion of the first clutch member having a joining face spaced apart from its coupling face and being formed with a first pilot, wherein the first member is mounted for rotation about an axis, the coupling face of each recess portion having at least one recess, each of the recesses defining a load-bearing shoulder; and
a powdered metal hub having a large number of pores, the hub including an axially extending connecting portion and a mounting portion being formed with a second pilot wherein the mounting portion of the hub is joined to the recess portion of the first member at a joint at the joining face and wherein the first and second pilots are in contact at a pilot diameter to concentrically align the hub and the first member during joining to improve performance of the assembly during a high-speed overrun condition.

14. The assembly as claimed in claim 13, wherein the joint is a brazed joint comprising a solid metal layer to bond the first member and the hub together.

15. The assembly as claimed in claim 14, wherein the brazed joint includes a brazed alloy infiltrated into the pores of the hub and the first member.

16. The assembly as claimed in claim 13, wherein each recess of the first member is sized and shaped to receive and retain a locking member that moves in its recess during the overrun condition of the assembly.

17. The assembly as claimed in claim 13, wherein the first and second pilots are curved surfaces.

18. The assembly as claimed in claim 13, wherein the first member is a pocket plate member.

19. The assembly as claimed in claim 16, wherein each locking member is either a locking strut or an impact energy storage element.

20. The assembly as claimed in claim 13, wherein the first and second pilots are annular surfaces.

21. The assembly as claimed in claim 13, wherein each recess of the first member has a “T” shape.

22. The assembly as claimed in claim 13, wherein each recess of the first member has an inner recess for receiving a biasing spring.

23. The assembly as claimed in claim 13, wherein each coupling face is oriented to face axially along the axis.
